(19) United States
(12) Patent Application Publication
(10) Pub. No.: US 2017/0262545 A1
(43) Pub. Date: Sep. 14, 2017

(54) METHOD AND ELECTRONIC DEVICE FOR CRAWLING WEBPAGE

(71) Applicants: Le Holdings (Beijing) Co., Ltd., Beijing (CN); Lemobile Information Technology (Beijing) Co., Ltd., Beijing (CN)

(72) Inventor: Wu Qu, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/247,750

(22) Filed: Aug. 25, 2016

Related U.S. Application Data
(63) Continuation of application No. PCT/CN2016/087848, filed on Jun. 30, 2016.

(30) Foreign Application Priority Data
Mar. 9, 2016 (CN) 201610133041.7

(51) Int. Cl. G06F 17/30

(52) U.S. Cl. CPC G06F 17/30867; G06F 17/30876

(57) ABSTRACT

Disclosed are a method and electronic device for crawling a webpage, wherein the method includes: acquiring a crawling cycle of the webpage, and calculating the time when the webpage is re-crawled; determining that the time when a webpage is to be re-crawled is earlier than the current time, and re-adding the webpage into a to-be-crawled webpage queue; and performing webpage re-crawling based on the to-be-crawled webpage queue.

### CROSS REFERENCE TO RELATED APPLICATIONS

The present disclosure is a continuation of International Application No. PCT/CN2016/087848, filed on Jun. 30, 2016, which is based upon and claims priority to Chinese Patent Application No. 201610133041.7, filed on Mar. 9, 2016, the entire contents of all of which are incorporated herein by reference.

### TECHNICAL FIELD

The present disclosure relates to the technical field of network information processing, and specifically relates to a method and an electronic device for crawling a webpage.

### BACKGROUND

A search engine brings a lot of convenience to the daily life of a user, the user can input relatively concerned keywords through the search engine, and the search engine will return contents associated with these keywords to the user.

The user always hopes to get more accurate and newer contents; each website recorded by the search engine also hopes that the search engine can index its own latest contents. A Web Crawler provides network resources to be indexed for the search engine, and plays a very important role in the search engine. In order to obtain relatively new contents in time to achieve a higher user experience while reducing the cost of optimizing the experience, the webpage update strategy of the Web Crawler is particularly important.

However, the existing open-source web crawler solutions typically only involve single crawling of a webpage, and do not provide update strategies for the crawled webpage. Relatively popular open-source web crawlers including Larbin, Nutch, Heritrix and the like only craw a webpage once. So when crawling is carried out by use of open-source solutions, a compromise proposal is typically adopted for updating a webpage: a strategy for regular reset and regular re-crawling of fixed-type webpages. Although the proposal solves the problem of updating the webpage, it cannot automatically adapt to webpage update frequency variations of various websites, and when the quantity of the crawled websites reaches a certain level, the workload of manual maintenance makes this solution exist in name only.

### SUMMARY

The embodiments of the present disclosure provides a method for crawling a webpage including: acquiring a crawling cycle of the webpage, and calculating crawling time when the webpage is to be re-crawled; determining the time when the webpage is re-crawled is earlier than a current time and then re-adding the webpage into a to-be-crawled webpage queue; and performing webpage re-crawling based on the to-be-crawled webpage queue.

The embodiments of the present disclosure provides an electronic device, including: at least one processor; and a memory communicably connected with the at least one processor for storing instructions executable by the at least one processor, wherein execution of the instructions by the at least one processor causes the at least one processor to acquire a crawling cycle of the webpage, and calculate time when the webpage is to be re-crawled; determine the time when the webpage is to be re-crawled is earlier than the current time, and re-adding the webpage into a to-be-crawled webpage queue; and performing webpage re-crawling based on the to-be-crawled webpage queue.

The embodiments of the present disclosure provides a non-transitory computer-readable storage medium storing executable instructions that, when executed by an electronic device, cause the electronic device to acquire a crawling cycle of the webpage, and calculate the time when the webpage is to be re-crawled; determine that the time when a webpage is to be re-crawled is earlier than the current time, and re-adding the webpage into a to-be-crawled webpage queue; and perform webpage re-crawling based on the to-be-crawled webpage queue.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a process flow diagram of the method for crawling a webpage according to an embodiment of the present disclosure;

FIG. 2 is a schematic diagram of a process flow of webpage collection in the prior art;

FIG. 3 is a schematic diagram (I) of a process flow of webpage collection after an automatic incremental update scheduling component is added according to an embodiment of the present disclosure;

FIG. 4 is a schematic diagram of the internal support structure of an automatic incremental update scheduling component according to an embodiment of the present disclosure;

FIG. 5 is a schematic diagram (II) of a process flow of webpage collection after an automatic incremental update scheduling component is added according to an embodiment of the present disclosure;

FIG. 6 is a schematic diagram of periodical scheduling after an automatic incremental update scheduling component is added according to an embodiment of the present disclosure;

FIG. 7 is a structural block diagram of a device for crawling a webpage according to an embodiment of the present disclosure;

FIG. 8 is a structural block diagram of an acquisition module according to an embodiment of the present disclosure;

FIG. 9 is another structural block diagram of the acquisition module according to an embodiment of the present disclosure;

FIG. 10 is another structural block diagram of the device for crawling a webpage according to an embodiment of the present disclosure;

FIG. 11 is a structural block diagram of a second acquisition unit according to the embodiments of the present disclosure;

FIG. 12 is a block diagram of the electronic device provided by one embodiment of the present disclosure.

### DETAILED DESCRIPTION

In order to clearly describe objectives, the technical solutions and advantages of the present disclosure. A clear and complete description of the technical solutions in the present disclosure will be given below, in conjunction with the accompanying drawings in the embodiments of the present disclosure. Apparently, the embodiments described below are a part, but not all, of the embodiments of the present disclosure

Embodiments provide a method for crawling a webpage. FIG. 1 is a process flow diagram of a method for crawling a webpage according to an embodiment of the present disclosure. As shown in FIG. 1, the process flow includes the following steps:

In step S102, a crawling cycle of the webpage is acquired, and the time is calculated when the above-described webpage is to be re-crawled is;

In S104, the time when the webpage is to be re-crawled is determined earlier than the current time, and the webpage is re-added into a to-be-crawled webpage queue; and

In S106, webpage re-crawling is performed based on the to-be-crawled webpage queue.

Through the above-described steps, in the process of crawling a webpage, the crawling cycle of the webpage is acquired and the time when the webpage is to be re-crawled is calculated. In the case that the calculated time is earlier than the current time, the webpage is re-added into the to-be-crawled webpage queue and is ready to be re-crawled. In comparison with the prior art which all webpages are regularly re-crawled once, the above-described steps solves the problem of inability to automatically adapt to the webpage updating frequency in the prior art because regular re-crawling is required for webpage updating under the condition that an open-source web crawler only can perform single crawling on a webpage, therefore, the crawling cycle of each webpage can be continuously adjusted, the webpages are updated in time, the cost of re-crawling a large number of webpages which are not updated is reduced, and the timeliness of a search engine is improved.

In the case, the above-described current time is the time when a webpage is pre-crawled.

Here, a webpage is re-added into the to-be-crawled webpage queue according to the periodicity of the webpage, which is greatly different from regular crawling in the prior art. One query may be periodically performed according to the periodical re-queuing in this alternative embodiment to determine whether there is any URL required to be re-queued, instead of re-crawling all URLs regularly, where different intended purposes are achieved in different timing modes.

The above step S102 involves that the crawling cycle of the webpage is acquired. In an alternative embodiment, the accumulated time from the time when the webpage is crawled for the first time to the current time is acquired, the number of times that the content of the webpage is changed during the accumulated time is acquired, and the ratio of the accumulated time to the number of times is calculated to obtain the crawling cycle of the webpage. Through this alternative embodiment, a shorter crawling cycle of the webpage means that the content of the webpage is changed faster, and in this case, the time when the webpage is to be re-crawled needs to be shortened; and a longer crawling cycle of the webpage means that the content of the webpage is changed slower, and in this case, the time when the webpage is to be re-crawled needs to be prolonged.

The above step S102 further involves that the time when the webpage is to be re-crawled is calculated. In an alternative embodiment, the above-described time when the webpage is to be re-crawled is obtained by acquiring the crawling time when the webpage is last crawled and performing a summation operation on the crawling time and the crawling period.

After webpage re-crawling is performed based on the to-be-crawled webpage queue, in an alternative embodiment, the webpage is sorted by ascending order according to the time when the webpage is to be re-crawled; whether the time when the webpage is to be crawled is earlier than the current time or not is determined, and if the time when the webpage is to be crawled is earlier than the current time, the time when the webpage is to be crawled is updated to be an ultra-high value, and the webpage is re-added into the to-be-crawled webpage queue. The time when the webpage is to be re-crawled is updated to be the ultra-high value, so that the webpage is prevented from being re-crawled in the next period.

In the process of acquiring the crawling cycle of the webpage, the number of times that the content of the webpage is changed in the accumulated time needs to be acquired. It should be noted that the number of times that the content of the webpage is changed in a certain period of time may be acquired in multiple ways, which will be illustrated below. In one alternative embodiment, a first SimHash value of crawling the webpage this time and a second SimHash value of crawling the webpage last time are obtained, the first SimHash value and the second SimHash value are compared by using a Hamming distance algorithm to obtain a comparison result. Whether the comparison result is greater than a predetermined threshold is determined, and if the comparison result is greater than a predetermined threshold, the content is determined to have been changed, so that the number of times that the content of the webpage has been changed can be counted during the accumulated time. The predetermined threshold can be adjusted according to actual conditions, for example, the predetermined value may be 5.

In the process of acquiring the SimHash values of the webpage, according to an alternative embodiment, word segmentation processing is performed on the webpage to obtain a word array of an n-dimensional vector, and a SimHash operation is performed on the word array to obtain the SimHash value of the webpage.

Hereinafter, a webpage automatic incremental update scheduling component which is based on SimHash and the Hamming distance algorithm and supported by a Redis technology is described as a specific alternative embodiment.

In step 1. webpage parameters are designed and stored, where the following parameters of each crawled webpage is saved by using Redis:

parameter t: records the time passed from the time a webpage is crawled the first time to the current time;

parameter x: records the number of times that the content of the webpage is changed during the time t;

parameter last: records the time when the webpage is last crawled;

parameter next: records the time when the webpage is next crawled; and

parameter hash: records the SimHash values of the webpage during the crawling last time.

In Step 2. the above parameters are updated after every crawling:

In Step 2.1: the text of a crawled webpage is obtained, and the process proceeds to Step 2.2;

In Step 2.2: word segmentation is performed on the texts of the webpage to obtain an n-dimensional vector as an input of a SimHash algorithm, a SimHash value h1 is outputted, and then the process proceeds to step 2.3;

In Step 2.3: a determination is made as to whether the webpage is crawled the first time; if so, the process proceeds to step 2.4, otherwise, proceeds to step 2.5;

In Step 2.4: the parameters are set: t=0, x=1, last=the current time (in a self-defined unit), next=the current time+a temporary value, and hash=h1;

Step 2.5: the parameters are set, and the SimHash value h1 of the current algorithm is compared with the SimHash value hash generated in the last crawling by using a Hamming distance algorithm; and if the comparison result exceeds a certain fixed threshold, the webpage is considered to be updated; and if the webpage has been updated, the process precedes to Step 2.6, otherwise, the process goes to Step 2.7;

In Step 2.6: the parameters are set: t=t+(the current time−last), x=x+1, last=the current time (in a self-defined unit), next=last+t/x, and hash=h1; and

In Step 2.7: the parameters are set: t=t+(the current time−last), x=x, last=the current time (self-defined unit), next=last+t/x, and hash=h1.

In Step 3. the webpages which has been already crawled is periodically re-queued:

The crawled webpages are sorted by ascending order according to the value next. Each time the first in enters is taken, a determination is made as to whether the value next is smaller than or equal to the current time. If the value is earlier than the current time, the next needs to be updated to be an ultra-high value (the URL is prevented from being taken out in the next cycle, no action is taken when the next is updated to the ultra-high value; and after crawling, the next will also be assigned with a new value for the next crawling), and re-queuing and re-crawling is performed, so that incremental updating is achieved.

In this case, by way of example and not limitation, in can be within 1000 to 10000.

That is to say, every time a webpage is crawled, two main attributes, next value and SimHash value, which represent the current state of the webpage, may be calculated. The value next equals to division of the accumulated time from the time when the webpage is crawled for the first time to the current time by the number of times that the webpage is changed till the current time, plus the time when the webpage is last crawled. The value SimHash is obtained by the process: a word segmentation component performs Chinese word segmentation on the webpages to form a array of words, which is used as an input of a SimHash algorithm to perform an algorithm operation, so that for each webpage, one hash value is outputted as a fingerprint of the current state. After the two values are recorded, the values next may be sorted by ascending order, in which a webpage with small value of next may be placed in the front. Some webpages that are placed at the top every time are re-crawled periodically (or in a way of a 24 h). During the time that the webpages are re-crawled, a new calculated Hash fingerprint is compared with the previous Hash fingerprint by using the Hamming distance algorithm, by which the similarity of two webpages is calculated (the number of binary (strings of 0 s and 1 s) values corresponding to two simhashes which are different is known as the Hamming distance of the two simhashes); in other words, the ratio of change of a same webpage may be calculated. Therefore, when the ratio of change exceeds a certain value, the number of times that the webpage is changed may be incremented by one. In this way, as the system is continuously running, the value next may be changed continuously to influence the crawling frequency of each webpage.

Redis may be used in the technical solution of the alternative embodiment of the present disclosure, and is implemented as a URL storage structure. The Redis has rich data structures that may be utilized and has a persistence function, so that the risk of data loss is reduced. The Redis is composed of key values, key->value (character string)->value structure objects (Hset, Zset, List, Set).

A List data structure may act as a URL queue;

A Set data structure may act as a URL duplicate removal set;

A Hset data structure may save the state of a webpage, and a hset value structure is composed of field and value, wherein the field represent a key in the value structure, and the value represent a value; and

A Zset data structure is an ordered set and can realize sorting the webpages of different updating frequencies. A Zset value structure is composed of score and value, wherein the score represent a score (the basis of sorting), and the value represent a value.

### 1. Design of Redis Key Values:

Design of zset

| Key | Score | value |
|---|---|---|
| sitename_zset | Next | url |

Design of hset

| Key | Field | value |
|---|---|---|
| sitename_hset | url | ‘{t:**,x:**,last:**,hash:**}’ |

Design of list

| Key | Value |
|---|---|
| sitename_queue | url |

Design of set

| Key | Value |
|---|---|
| sitename_set | url |

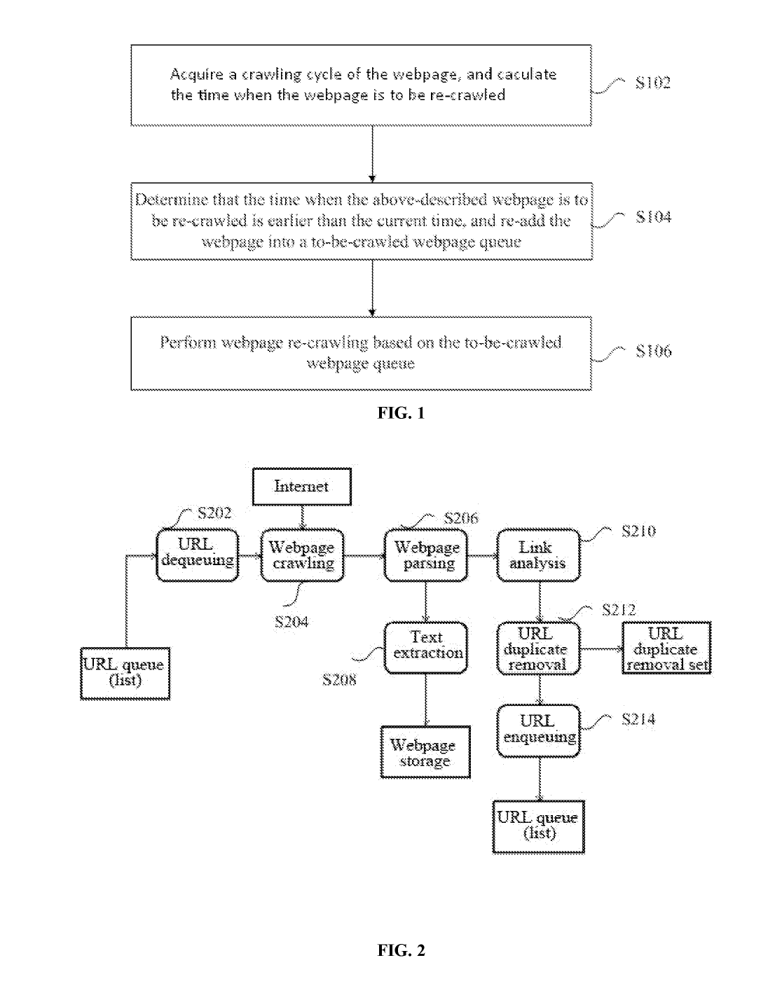

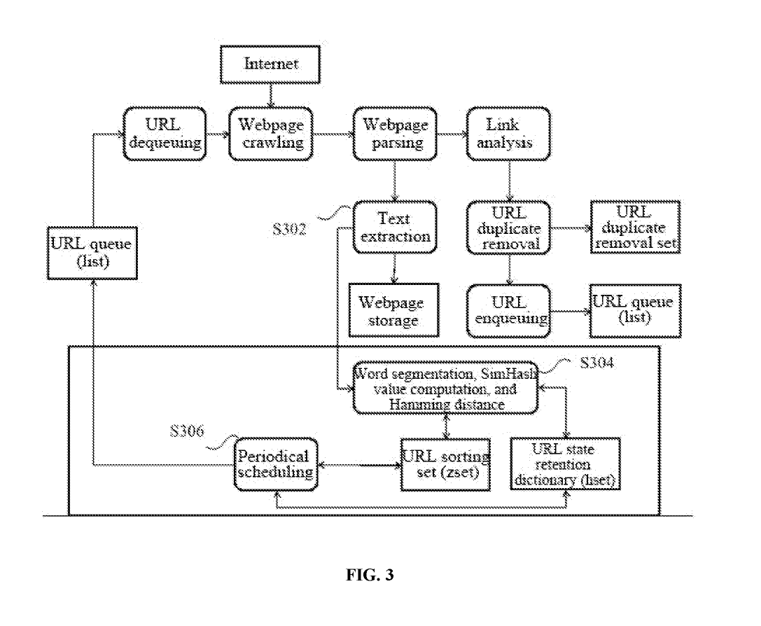

FIG. 2 is a schematic diagram of the process flow of webpage collection. As shown in FIG. 2, the process flow includes the following steps:

In S202, URL dequeuing is performed, wherein: a to-be-crawled URL from a URL queue (list) is acquired as an input, and the URL also is an output;

In S204, a webpage is crawled from the Internet as a secondary input according to the URL output in S202, wherein the output is a crawled network resource;

In S206, webpage parsing is performed, wherein, document type parsing is performed according to the output of S204, and whether to carry out link analysis and text extraction or not is determined (non-text documents do not need link analysis) according to different document types;

In S208, text extraction is performed, wherein, text extraction is performed on a document according to the output of S206, wherein the output is the text of the document and is saved as a webpage;

In S210, link analysis is performed, wherein, link analysis is performed according to the output result in S206, and a link set is output;

In S212, URL duplicate removal is performed, wherein: overall URL duplicate removal is performed according to the link set output in S210, and non-repetitive URLs will be stored into a URL duplicate removal set and output to the next step to carry out an enqueue operation; and

In S212, URL queuing is performed, wherein, an queuing operation is performed according to the URL set output after duplicate removal in S212, and URLs are stored in a URL queue.

Hereafter, the program forms a self closed loop and keeps running until there is no resource to be crawled.

FIG. 3 is a schematic diagram (I) of the flow of webpage collection after adding an automatic incremental update scheduling component according to the embodiments of the present disclosure. As shown in FIG. 3, the flow includes the following steps:

After a webpage automatic incremental update scheduling component is added, the component will be introduced into S208 in the FIG. 2.

In S302, text extraction is performed, wherein, document text extraction is performed according to the output of the previous step, and the output is a document text which is stored as a webpage and is output to the incremental update scheduling component at the same time;

In S304, word segmentation is performed, and a SimHash value and a Hamming distance are calculated, wherein, a SimHash value is calculated by performing Chinese word segmentation on the webpage text output in S302 and an output word array; if a webpage is not crawled for the first time, the SimHash value needs to be compared with the previous SimHash value to calculate the Hamming distance. Through a series of theses algorithms, the state values (t, x, last, hash, next) of the webpage, which are required to be saved by the component, are obtained, and are saved in a URL state retention dictionary and a URL sorting set, respectively; and

In S306, periodic scheduling is performed, wherein, determinations are periodically and actively made according to the values next in the URL sorting set, and re-outputting URLs which needs to be re-queued to the URL queue (if any other attributes of the link need to be acquired, the URL state retention dictionary needs to be queried);

Hereafter, the program forms a self closed loop and keeps running to perform incremental crawling.

The URL queue: see the design of Redis key values and the design of list; the URL duplicate removal set: see the design of Redis key values and the design of set; the URL sorting set: see the design of Redis key values and the design of zset; and the URL state retention dictionary: see the design of Redis key values and the design of hset.

In comparison with the prior art, after the automatic incremental update scheduling component is added, the process step of saving a webpage retention state and periodically re-adding out-of-date webpages into the URL queue is added in the collection process flow. Although the process of calculating the hash values of webpages is additionally introduced into the design, crawling and calculation of a large number of duplicated webpages is removed and crawling bandwidth is saved; and meanwhile, the access pressure of some small websites which are not updated frequently is also reduced by dynamically adjusting the crawling frequency.

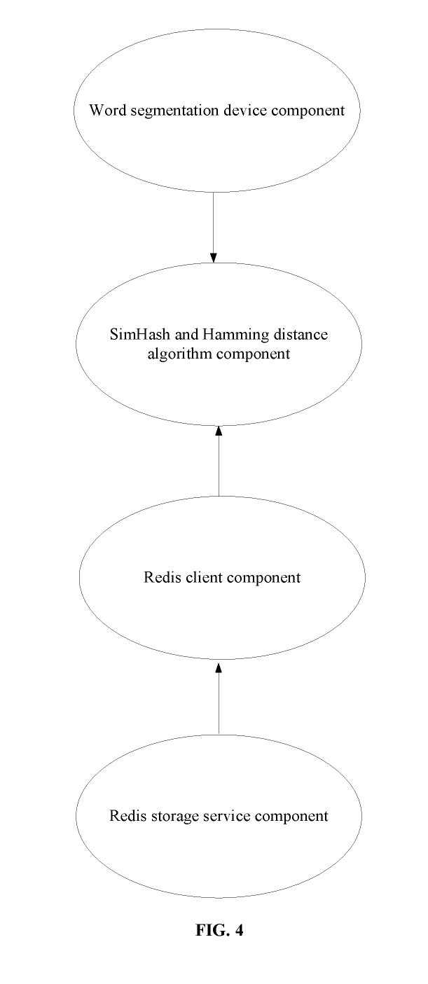

FIG. 4 is a schematic diagram of the internal support structure of an automatic incremental update scheduling component according to the embodiments of the present disclosure, where through the storage service provided by Redis, FIG. 4 shows a supporting relationship inside the component. According to the overall business process, in the process of program execution, other components provide a direct or indirect supporting relationship for SimHash and a Hamming distance algorithm component, a word segmentation device component provides a supporting relationship for SimHash and the Hamming distance algorithm component, and directly calls the component to carry out word segmentation, a Redis client component provides a supporting relationship for SimHash and the Hamming distance component and directly calls the component to acquire storage data, and the Redis client component also provides a supporting relationship for a Redis storage service component and acquires the storage data through a remote interface to indirectly support SimHash and the Hamming distance component.

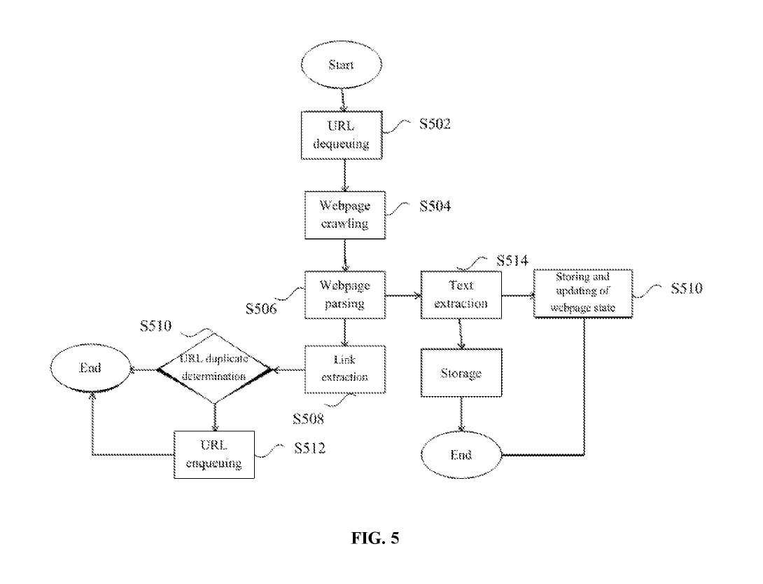

FIG. 5 is a schematic diagram (II) of the flow of webpage collection after adding the automatic incremental update scheduling component according to the embodiments of the present disclosure. As shown in FIG. 5, the flow includes the following steps:

In S502, URL dequeuing is performed, wherein, a to-be-crawled URL is acquired from a URL queue (list) as an input, and the output is also the URL;

In S504, webpage crawling is performed, wherein, a webpage is crawled from the internet as a secondary input according to the URL output in S502, and the output is a crawled network resource;

In S506, webpage parsing is performed, wherein, document type parsing is performed according to S504, and whether to carry out link analysis and text extraction or not is determined (non-text documents do not need link analysis) according to different document types, performing S508 when link analysis is needed, and S514 is performed when text extraction is needed;

In S508, link analysis is performed, wherein, link analysis is performed according to the output result in S506, and a link set is output.

In S510, URL duplicate removal is performed, wherein, overall URL duplicate removal is performed according to the link set output in S508, and non-repetitive URLs will be stored into a URL duplicate removal set and output to the next step to carry out an enqueue operation;

In S512, URL enqueuing is performed, wherein, an enqueuing operation is performed according to the URL set output after duplicate removal in S510, and URLs are stored in a URL queue; and

In S514, text extraction is performed, wherein, document extraction is performed according to the output result of S506, and the output is a document text which is stored as a webpage.

Hereinafter, the program forms a self-closed loop and keeps running until there is no to-be-crawled resource.

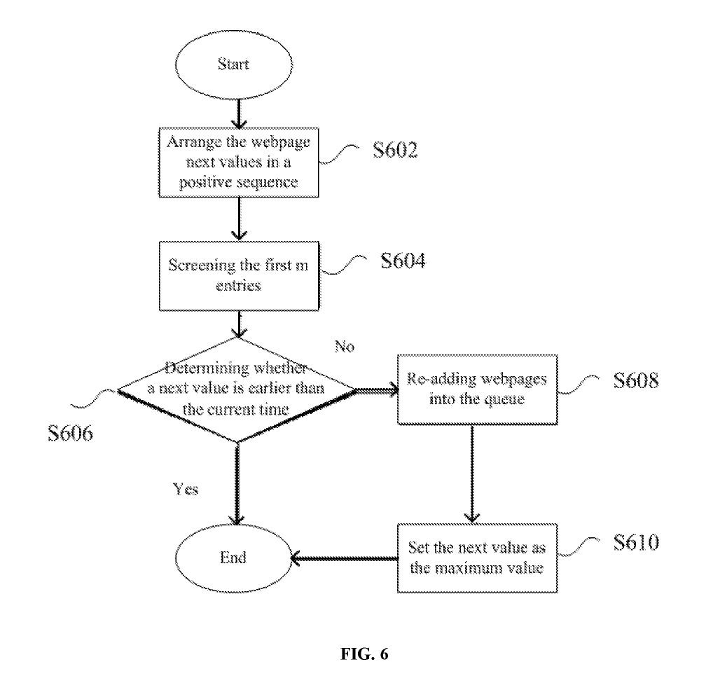

FIG. 6 is a schematic diagram of regular scheduling after the automatic incremental update scheduling component is added according to the embodiments of the present disclosure. As shown in FIG. 6, the flow includes the following steps:

In S602, sorting of ascending order is performed on values next of webpages;

In S604, the first in entries are screened;

In S606, whether the values next are earlier than the current time or not is determined; if the values next are earlier are not earlier than the current time, S608 is performed, and if the values next are earlier are earlier than the current time, execution is ended;

In S608, the webpage into a queue is re-added; and

In S610, the value next to be a maximum value is setting.

FIG. 5 and FIG. 6 are tTwo different process flows of an automatic incremental update scheduling component respectively, which are divided into two parts, a state retention part and a regular scheduling part.

Embodiments provide a device for crawling a webpage, which is configured for implementing the above embodiment and alternative embodiment, and what has been described will not be described again. As used below, the term “module” can realize the combination of software and/or hardware with predetermined functions. Although the device described by the following embodiment is preferably implemented in software, the implementation of hardware or the combination of the software and the hardware also may be possible and conceived.

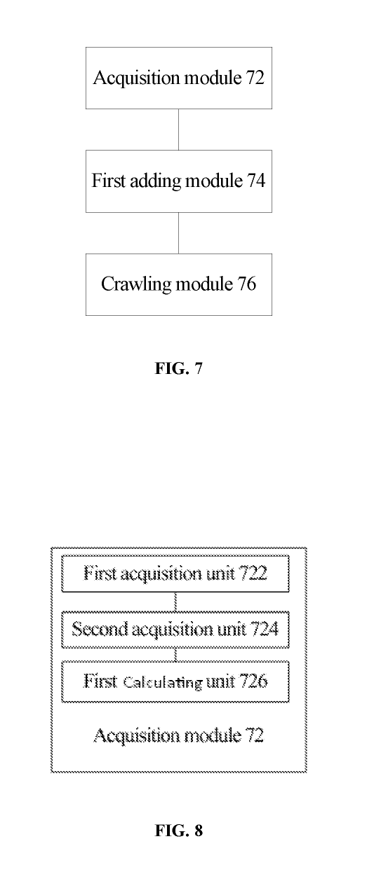

As shown in FIG. 7, the device includes an acquisition module 72 that acquires the crawling cycle of the webpage is crawled and calculates the time when the webpage is to be re-crawled; a first adding module 74 that, determines that the time when a webpage is to be re-crawled is earlier than the current time and re-adds the webpage into a to-be-crawled webpage queue; and a crawling module 76 that performs webpage re-crawling in the to-be-crawled webpage queue.

As shown in FIG. 8, the acquisition module 72 includes a first acquisition unit 722 that obtains the accumulated time from the time when the webpage is crawled for the first time to the current time; a second acquisition unit 724 that acquires the number of times that the content of the webpage is changed during the accumulated time; and a first calculating unit 726 that obtains the crawling cycle by calculating the ratio of the accumulated time and the number of times.

As shown in FIG. 9, the acquisition module 72 further includes a third acquisition unit 728 that acquires the crawling time when the webpage is crawled last time; and a second calculating ing unit 730 that performs a summation operation on the crawling time and the crawling period to obtain the time when the webpage is to be re-crawled.

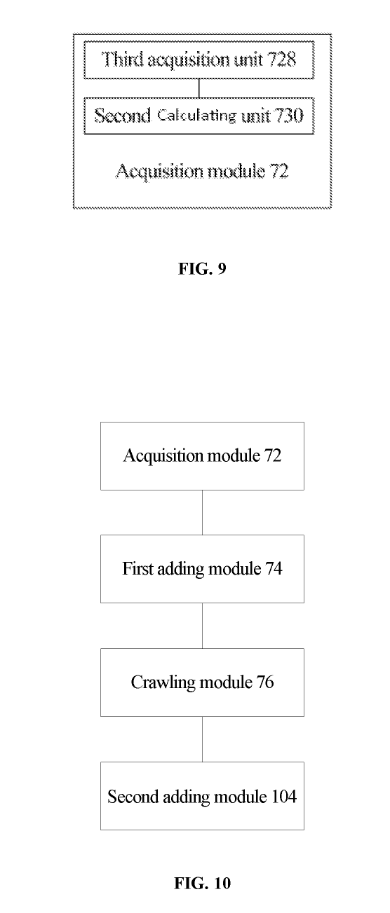

As shown in FIG. 10, the device also includes a second adding module 104 that determines whether the time when the webpage is to be re-crawled is earlier than the current time or not or not, if the time when the webpage is to be re-crawled is earlier than the current time, the time when the webpage is to be re-crawled is updated to be an ultra-high value, and the webpage is re-added into a to-be-crawled webpage queue.

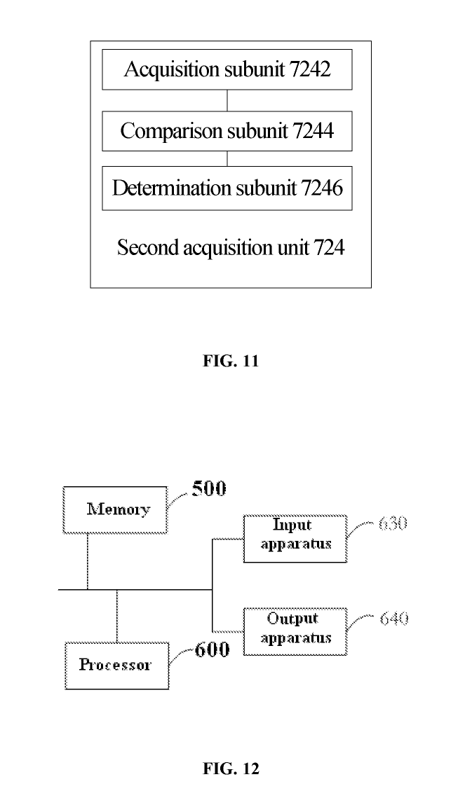

As shown in FIG. 11, the second acquisition unit 724 includes an acquisition subunit 7242 that acquires a first SimHash value for crawling the webpage this time and a second SimHash value for crawling the webpage last time; a comparison subunit 7244 that compares the first SimHash value with the second SimHash value by using a Hamming distance algorithm to obtain a comparison result; and a determination subunit 7246 that determines whether the comparison result is greater than a predetermined threshold or not, and if the comparison result is greater than a predetermined threshold, the content of the webpage has been changed is determined.

Alternatively, the acquisition subunit 7242 also performs word segmentation processing on the webpage to obtain a word array of an n-dimensional vector; and performs a SimHash operation on the word array to obtain a SimHash value of the webpage.

Embodiments of the present disclosure provide a non-transitory computer-readable storage medium storing executable instructions that, when executed by an electronic device, cause the electronic device to perform any of the embodiments described above of the method for crawling a webpage.

### Embodiment 4

FIG. 12 is a block diagram of the electronic device provided by the embodiment, which performs the method for crawling a webpage. As shown in FIG. 12, the electronic device includes: one or more processors 600 and a memory 500, wherein one processor 600 is shown in FIG. 12 as an example. The electronic device that performs the method for crawling a webpage further includes an input apparatus 630 and an output apparatus 640.

The processor 600, the memory 500, the input apparatus 630 and the output apparatus 640 may be connected via a bus line or other means, wherein connection via a bus line is shown in FIG. 12 as an example.

The memory 500 is a non-transitory computer-readable storage medium that can be used to store non-transitory software programs, non-transitory computer-executable programs and modules, such as the program instructions/modules corresponding to the method for crawling a webpage of the embodiments of the present disclosure (e.g. acquisition module 72, first addition module 74, crawling module 76, the recognition unit, and the execution unit shown in the FIG. 7). The processor 56 executes the non-transitory software programs, instructions and modules stored in the memory 500 so as to perform various function application and data processing of the server, thereby implementing the Method for crawling a webpage of the above-mentioned method embodiments

The memory 500 includes a program storage area and a data storage area, wherein, the program storage area can store an operation system and application programs required for at least one function; the data storage area can store data generated by use of the device for crawling a webpage. Furthermore, the memory 500 may include a high-speed random access memory, and may also include a non-volatile memory, e.g. at least one magnetic disk memory unit, flash memory unit, or other non-volatile solid-state memory unit. In some embodiments, optionally, the memory 500 includes a remote memory accessed by the processor 56, and the remote memory is connected to the device for crawling a webpage via network connection. Examples of the aforementioned network include but not limited to internet, intranet, LAN, GSM, and their combinations.

The input apparatus 630 receives digit or character information, so as to generate signal input related to the user configuration and function control of the device for crawling a webpage. The output apparatus 640 includes display devices such as a display screen.

The one or more modules are stored in the memory 500 and, when executed by the one or more processors 600, perform the method for crawling a webpage of any one of the above-mentioned method embodiments.

The above-mentioned product can perform the method provided by the embodiments of the present disclosure and have function modules as well as beneficial effects corresponding to the method. Those technical details not described in this embodiment can be known by referring to the method provided by the embodiments of the present disclosure.

The electronic device of the embodiments of the present disclosure can exist in many forms, including but not limited to:
1) Mobile communication devices: The characteristic of this type of device is having a mobile communication function with a main goal of enabling voice and data communication. This type of terminal device includes: smartphones (such as iPhone), multimedia phones, feature phones, and low-end phones.
2) Ultra-mobile personal computer devices: This type of device belongs to the category of personal computers that have computing and processing functions and usually also have mobile internet access features. This type of terminal device includes: PDA, MID, UMPC devices, such as iPad.
3) Portable entertainment devices: This type of device is able to display and play multimedia contents. This type of terminal device includes: audio and video players (such as iPod), handheld game players, electronic books, intelligent toys, and portable GPS devices.
4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.
5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the present disclosure, without restricting the technical scheme of the present disclosure. Although detailed description of the present disclosure is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the present disclosure.

What is claimed is:

1. A method for crawling a webpage, comprising at an electronic device:
acquiring a crawling cycle of the webpage, and calculating the time when the webpage is to be re-crawled;
determining that the time when the webpage is to be re-crawled is earlier than the current time, and re-adding the webpage into a to-be-crawled webpage queue; and
performing webpage re-crawling based on the to-be-crawled webpage queue.

2. The method of claim 1, wherein the acquiring a crawling cycle of the webpage comprises:
acquiring the accumulated time from the time when the webpage is crawled for the first time to the current time;
acquiring number of times that content of the webpage is changed during the accumulated time; and
calculating ratio of the accumulated time and the number of times to obtain the crawling cycle.

3. The method of claim 1, wherein the calculating the time when the webpage is to be re-crawled comprises:
acquiring a crawling time when the webpage is last crawled; and
performing a summation operation on the crawling time and the crawling cycle to obtain the time when the webpage is to be re-crawled.

4. The method of claim 1, wherein after the performing webpage re-crawling in the to-be-crawled webpage queue, the method further comprises:
determining whether the time when the webpage is to be re-crawled is earlier than the current time or not; and updating the time when the webpage is to be re-crawled to be an ultra-high value, and re-adding the webpage into the to-be-crawled webpage queue, if the time when the webpage is to be re-crawled is earlier than the current time.

5. The method of claim 2, wherein the acquiring the number of times that the content of the webpage is changed during the accumulated time comprises:
acquiring a first SimHash value for crawling the webpage this time and a second SimHash value for crawling the webpage last time;
comparing the first SimHash value with the second SimHash value by using a Hamming distance algorithm to obtain a comparison result; and
determining whether the comparison result is greater than a predetermined threshold or not, and determining that the content of the webpage has been changed, if the comparison result is greater than a predetermined threshold.

6. The method of claim 5, wherein the acquiring the SimHash value of the webpage comprises:
performing word segmentation processing on the webpage to obtain a word array of an n-dimensional vector; and
performing a SimHash operation on the word array to obtain a SimHash value of the webpage.

7. An electronic device, comprising:
at least one processor; and
a memory communicably connected with the at least one processor for storing instructions executable by the at least one processor, wherein execution of the instructions by the at least one processor causes the at least one processor to:
acquire a crawling cycle of the webpage, and calculate the time when the webpage is to be re-crawled;
determine that the time when a webpage is to be re-crawled is earlier than the current time, and re-adding the webpage into a to-be-crawled webpage queue; and
perform webpage re-crawling based on the to-be-crawled webpage queue.

8. The Electronic device of claim 7, wherein the execution of the instructions to acquire the crawling cycle of the webpage causes the at least one processor to:
acquire the accumulated time from the time when the webpage is crawled for the first time to the current time;
acquire the number of times that the content of the webpage is changed during the accumulated time; and
calculate ratio of the accumulated time and the number of times to obtain the crawling cycle.

9. The Electronic device of claim 7, wherein the execution of the instructions to calculate the time when the webpage is to be re-crawled causes the at least one processor to:
acquire the crawling time of crawling the webpage the last time; and
perform a summation operation on the crawling time and the crawling cycle to obtain the time when the webpage is to be re-crawled.

10. The Electronic device of claim 7, wherein the electronic device is further caused to:
determine whether the time when the webpage is to be re-crawled is earlier than the current time or not; and, update the time when the webpage is to be re-crawled to be an ultra-high value, and re-add the webpage into the to-be-crawled webpage queue, if the webpage is to be re-crawled is earlier than the current time.

11. The Electronic device of claim 7, wherein the execution of the instructions to acquire the number of times that the content of the webpage is changed during the accumulated time causes the at least one processor to:
acquire a first SimHash value for crawling the webpage this time and a second SimHash value for crawling the webpage last time;
compare the first SimHash value with the second SimHash value by using a Hamming distance algorithm to obtain a comparison result; and
determine whether the comparison result is greater than a predetermined threshold or not, and determine that the content of the webpage has been changed, if the comparison result is greater than a predetermined threshold.

12. The Electronic device of claim 10, wherein
the execution of the instructions to acquire the SimHash value of the webpage causes the at least one processor to:
perform word segmentation processing on the webpage to obtain a word array of an n-dimensional vector; and
perform a SimHash operation on the word array to obtain a SimHash value of the webpage.

13. A non-transitory computer-readable storage medium storing executable instructions that, when executed by an electronic device causes the electronic device to:
acquire a crawling cycle of the webpage, and calculate the time when the webpage is to be re-crawled;
determine that the time when a webpage is to be re-crawled is earlier than the current time, and re-adding the webpage into a to-be-crawled webpage queue; and
perform webpage re-crawling based on the to-be-crawled webpage queue.

14. The non-transitory computer-readable storage medium of claim 13, wherein the execution of the instructions to acquire the crawling cycle of the webpage causes the electronic device to:
acquire the accumulated time from the time when the webpage is crawled for the first time to the current time;
acquire the number of times that the content of the webpage is changed during the accumulated time; and
calculate ratio of the accumulated time and the number of times to obtain the crawling cycle.

15. The non-transitory computer-readable storage medium of claim 14, wherein
the execution of the instructions to calculate the time when the webpage is to be re-crawled causes the electronic device to:
acquire the crawling time of crawling the webpage the last time; and
perform a summation operation on the crawling time and the crawling cycle to obtain the time when the webpage is to be re-crawled.

16. The non-transitory computer-readable storage medium of claim 13, wherein the electronic device is further caused to:
determine whether the time when the webpage is to be re-crawled is earlier than the current time or not; and update the time when the webpage is to be re-crawled to be an ultra-high value, and re-add the webpage into the to-be-crawled webpage queue, if the time when the webpage is to be re-crawled is earlier than the current time.

17. The non-transitory computer-readable storage medium of claim 13, wherein
the execution of the instructions to acquire the number of times that the content of the webpage is changed during the accumulated time causes the electronic device to:
acquire a first SimHash value for crawling the webpage this time and a second SimHash value for crawling the webpage last time;
compare the first SimHash value with the second SimHash value by using a Hamming distance algorithm to obtain a comparison result; and
determine whether the comparison result is greater than a predetermined threshold or not, and determining that the content of the webpage has been changed, if the comparison result is greater than a predetermined threshold.

18. The non-transitory computer-readable storage medium of claim 16, wherein, the execution of the instructions to acquire the SimHash value of the webpage causes the electronic device to:
perform word segmentation processing on the webpage to obtain a word array of an n-dimensional vector; and
perform a SimHash operation on the word array to obtain a SimHash value of the webpage.
